(19) United States
(12) Patent Application Publication
(10) Pub. No.: US 2020/0195731 A1
(43) Pub. Date: Jun. 18, 2020

(54) LCCS SYSTEM AND METHOD FOR EXECUTING COMPUTATION OFFLOADING

(71) Applicant: SICHUAN UNIVERSITY, Chengdu (CN)

(72) Inventors: Bing GUO, Chengdu (CN); Yan SHEN, Chengdu (CN); Junyu LU, Chengdu (CN)

(21) Appl. No.: 16/217,330

(22) Filed: Dec. 12, 2018

(51) Int. Cl. H04L 29/08; H04L 29/06

(52) U.S. Cl. CPC H04L 67/16; H04L 67/2838; H04W 52/0209; H04L 67/42; H04L 67/32

(57) ABSTRACT

The disclosure discloses a LCCS system comprising: a service terminal. The service terminal comprises a plurality of worker nodes and a master mode, the worker nodes comprises a plurality of servers, each server is used to provide at least one type of calculating service corresponding to one type of application installed in mobile terminals; and a plurality of mobile terminals, each mobile terminal is installed with at least one application, wherein the applications correspond to the calculating services provided by the servers. The beneficial effect of the invention at least lies in: the LCCS system is not only able to reduce the power consumption and enhance the performance of mobile terminals, but also reduce the burden of application development.

### FIELD OF TECHNOLOGY

The disclosure relates to the field of computer and, more particularly, to a Loose Coupling Client and Server framework (LCCS) system and method for executing computation offloading.

### BACKGROUND

Computation offloading is an effective approach to solve the problem that the scarce computing ability and battery capacity cannot satisfy the needs of numerous application on smart phones. It utilizes the remote resources from the cloud or other devices with abundant computing resources to supplement local resources via offloading computing intensive tasks to the remote end.

The increasing popularity of smart phones has brought the trend of mobile Internet, which has radically changed users lifestyle in recent decades. With their intrinsic portability, these smart devices give people the ability to access the Internet anytime and anywhere. To cater the increasingly function demands for users, the developers have developed a wide range of mobile applications, such as image processing, augmented reality and big scale games. While enjoying the pleasure and convenience of smart phones, users are also enduring the scarce computing ability and battery capacity brought by the portability. Unfortunately, battery technology innovation speed is far behind the innovation speed of processors. The development of battery technology is unable to satisfy the pursuit of smart phones performance and the demand for application varieties. On the other hand, through mobile cloud computing, the cross product of cloud computing and mobile Internet, mobile terminals can not only access more reliable services, but also eliminate deficiencies on performance and batteries, which has brought the revolution of these devices. As an important technology in mobile cloud computing, computation offloading is an effective approach to solve the problem of resource restriction in mobile terminal. This technology can accelerate the speed and diminish the power consumption of the task execution by offloading compute-intensive tasks to the cloud centers rich in tremendous storing ability and computing ability.

After Eduardo Cuervo first brought MAUI forward, computation offloading had captured increasing attention from the researchers in recent years because of its great potential. Many related works have been conducted in recent years. The implementation methods of these works can be divided into four categories. The first category is based on surrogate. The second category is based on cloudlet. The third category is based on mobile devices. The last category is based on the cloud.

In all existing related works, there is a problem that application developers are not able to access computing services in an efficient way. Due to the tight coupling of these models or heterogeneous architecture, application developers must make much efforts on deployment and maintenance for applying these compute offloading models.

### SUMMARY

The disclosure provides a Loose Coupling Client and Server framework (LCCS) system and method for executing computation offloading.

To solve the problems described in the prior art, the disclosure discloses a Loose Coupling Client and Server framework (LCCS) system and method for executing computation offloading.

According to an embodiment of the present disclosure, there is disclosed a LCCS system comprising: a cloud service terminal comprises a plurality of worker nodes and a master mode, the worker nodes comprises a plurality of servers, each server is used to provide at least one type of calculating service corresponding to one type of application installed in mobile terminals; and a plurality of mobile terminals, each mobile terminal is installed with at least one application, wherein the applications correspond to the calculating services provided by the servers.

According to an embodiment, each of the mobile terminal comprises an offload controller, a device profiler unit, a query unit, a code sync unit and a remote invoking unit; the offload controller is configured to determine whether the code of compute-intensive tasks should be offloaded based on device information collected by the device profiler unit; the device profiler unit is configured to monitor the execution and generate history records both in remote mode and local mode to help the offload controller make decisions; the query unit is configured to query whether the cloud service terminal includes the corresponding calculating service; the code sync unit is configured to synchronize the code of compute-intensive task to the worker nodes; and the remote invoking unit is configured to access the cloud service terminal and obtain the results.

According to an embodiment, the mobile terminal further comprises a local executor unit, and the local executor unit is configured to ensure the integrity of the application functionality.

According to an embodiment, the master node of the cloud service terminal is configured to handle offloading requests from mobile terminals and schedule new services; the master node comprises a server state collector unit, a service tracker unit and a scheduler unit; the server state collector unit is configured to collect states from worker nodes; the service tracker unit is configured to track different service statuses distributed on different worker nodes; the scheduler unit is configured to use the information from the service tracker unit to check whether the corresponding service exists and use the information from the server state collector unit to determine which worker node is going to generate and maintain a new service.

According to an embodiment, the worker node comprises a code sync unit, a code decorator unit, a service generator unit, a service manager unit and a server profiler unit; the code sync unit is configured to receive the code transmitted from the mobile terminal and put the code to a specific place; the code decorator unit is configured to decorate raw code using a tool code which is deployed previously and makes the decorated code compliable; the service generator unit is configured to generate corresponding service through a series of compilation and running actions; the service manager unit is configured to manage the lifecycle of each service; the server profiler unit is configured to collects its own statuses and send the information to the master node, wherein the own statues comprises CPU utilization rate, memory occupancy status, I/O occupancy status and occupied port number.

According to an embodiment, the worker node further comprises a service pool, the service pool is the word to describe the set that contains different kinds of services which have their own lifecycles.

According to an embodiment, the cloud service terminal comprises star topology distributed servers or peer-to-peer distributed servers.

According to an embodiment, the cloud service terminal comprises peer-to-peer distributed servers, the peer-to-peer distributed servers comprises a temporary master node to ensure the consistency of load information.

According to an embodiment, the cloud service terminal comprises star topology distributed servers, the cloud server includes an auxiliary node to help the master node update the server status information.

According to an embodiment, the cloud service terminal is further configured to perform node selection, comprising: server status update; worker node selection; and available service information update.

According to an embodiment, the cloud service terminal comprises peer-to-peer distributed servers, the peer-to-peer distributed servers comprises a temporary master node to ensure the consistency of load information, the cloud service terminal is further configured to perform node selection, comprising: temporary master node shift.

There is provided a method for executing computation offloading, comprising: establishing a connection with a master node and access the webservice interface provided by the master node; establishing an elementary unit for unified remote invocation; determining whether the corresponding calculating service exists; performing service deployment by code synchronization, code decoration and service generation.

According to an embodiment, in the step of performing service deployment by code synchronization, code decoration and service generation, the step of code synchronization comprises: providing an interface for applications to upload the original code, after receiving the code completely, putting the code into an interface file and implementation file at the specific position respectively; the step of code decoration comprises: getting the interface file content, appending behind the package name and putting it back; getting the tool code and the original code from the tool code file and implementation file respectively; extracting the proper code from the tool code and the original code using regular-expression related function, concatenating together and substituting the interface name to make the new-generated code be able to be compiled; the step of service generation comprises: code compilation phase and code start-up phase.

According to an embodiment, in step of establishing an elementary unit for unified remote invocation, an SDK tool is provided to realize remote invocation between the mobile terminal and the cloud service terminal with heterogeneous structures, the elementary unit has an interface named RemoteMessage and a class named RemoteInstance, both of them implement the interface serializable to achieve serial transmission through TCP, a class RemoteCall and a class RemoteReturn are used as the elementary unit for method invocation and returning respectively, and both of them implement the interface RemoteMessage.

According to an embodiment, step of determining whether the corresponding calculating service exists comprises: finding the appropriate worker node based on the information; once receives the request, inquiring the Service Tracker to determine the existence of the available service which refers to the latest version and time expiration of the service; if the service is the latest version and has not been terminated, getting the response containing address and port of the worker node where the corresponding service exists. otherwise, searching for the idlest worker node to deploy the new service.

According to an embodiment, the method further comprises: performing service lifecycle management.

Compared with the prior art, the disclosure has the following advantages:

1) LCCS system is not only able to reduce the power consumption and enhance the performance of mobile terminals, but also reduce the burden of application development.

2) LCCS system has a loose bond between applications and cloud servers with the heterogeneous underlying architecture, which makes cloud providers be able to provide generic but self-customized cloud offloading services for different applications.

3) In LCCS system and the method for executing computation offloading, the lifecycle mechanism is proposed for offloading services on cloud servers to further reduce the time and energy consumption of service deployment for the same application on different mobile terminals.

### BRIEF DESCRIPTION OF THE DRAWINGS

FIG. 1 is a schematic diagram showing the designing idea according an embodiment of the present disclosure.

FIG. 2 is a schematic diagram showing framework architecture of the Loose Coupling Client and Server framework (LCCS).

FIG. 3 is a block chart showing the structure of a service identity.

FIG. 4 shows the overall architecture of the server based on star topology.

FIG. 5 gives the server architecture based on peer-to-peer topology.

FIG. 6 shows a load information update according to an embodiment of the present disclosure.

### DESCRIPTION OF THE EMBODIMENTS

To make the objective, characteristics and advantages of the disclosure more apparent, hereinafter, the disclosure is illustrated more specifically in accompanying with the drawings and description.

The First Embodiment of the Loose Coupling Client and Server Framework (LCCS) System

The primary purpose for offloading systems is to enable terminals such as the smart phones to offload compute-intensive tasks to remote PCs or servers, so that it is capable to compensate deficiencies of smart phones in processing ability, storage and battery capacities and prolong the endurance of batteries. The ideas of designing the offloading system are as follows.

In the embodiment of the present application, there are two ideas of designing the offload system, the first is to assess the execution time and energy saving for offloading, and the second is to provide a generic self-customized service.

To the assessment on execution time and energy saving for offloading, in the embodiment of the present disclosure, it is capable to assess the effectiveness of execution time and energy saving for computation offloading.

From the perspective of power consumption, it is capable to make sure the offloading is carried out under the condition that Er<El, where El denotes the power consumption for a smart phone in which the compute-intensive task is executed on the smart phone locally, while Er represents the power consumption in which the compute-intensive task is offloaded to remote server and executed remotely. Generally, Er is usually equal to the network transmission power consumption.

From the perspective of personal use, if users won't notice the time delay of the offloading, then the offloading system won't affect the user experience of the application. It is capable to use Tl to denote the local execution time of the compute-intensive task, Tc as the time for communication delay, Td as the time for environment deployment, Tr for the remote execution time. The offloading is carried out when Tc+Td+Tr<Tl. In order to simplify the measurement, it is only needed to estimate the total time TR for computation offloading and compare it with the local execution time Tl, thereby assessing the effectiveness of the offloading.

To the generic self-customized service, the designing idea of the disclosure is to alleviate development burden by loosing the tight coupling structure between the Android smart phone and the server. The idea is that the server provides a computation offloading service for the same application installed on different mobile clients, which enables different mobile clients to access the customized offloading service by dynamically offloading compute-intensive tasks to the cloud. Application developers may not have to consider the implementation details of the server, which means they don't have to develop corresponding offloading server to support task remote execution anymore. Instead, in an embodiment, application developers only need to deploy the SDK to their applications and call the related methods to realize dynamic task offloading. Before computation offloading begins, the cloud server does not actually contain any codes or execution context correlated with application's functions. When computation offloading is initialized, applications synchronize their code to the server. It is up to developers to determine what codes they want to offload to the server, whether it's a whole class or just a well-encapsulated simple loop statement. That is, in one embodiment, a whole class codes may be offloaded to the server, and in other embodiments, a well-encapsulated simple loop statement may be offloaded to the server.

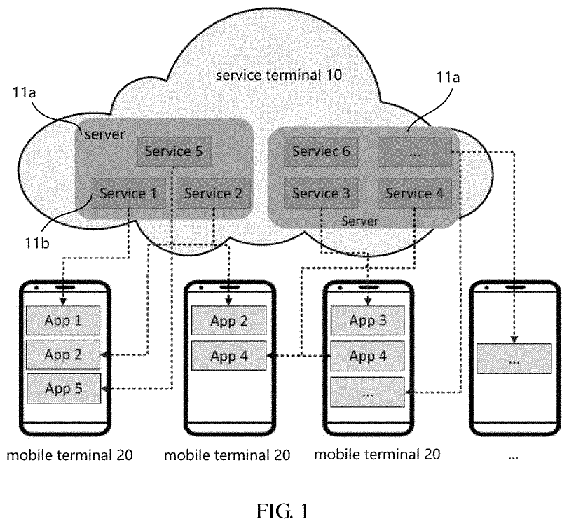

After the code synchronization completes, the server may generate a “Service i” for “App i” to invoke. FIG. 1 is a schematic diagram showing the designing idea according an embodiment of the present disclosure. As shown in FIG. 1, “App i” (including App 1, App 1 . . . App 5 . . . ) represents the ith application on Android smart phone while “Service i” (including Service 1, Service 2 . . . Service 6 . . . ) represents the corresponding service of ith application hold by Cloud Service Provider. A cloud service provider consists of different servers and each server can maintain different kinds of services, while smart phones usually install different applications. Nevertheless, the same application installed on different smart phones still can access their corresponding service exclusively.

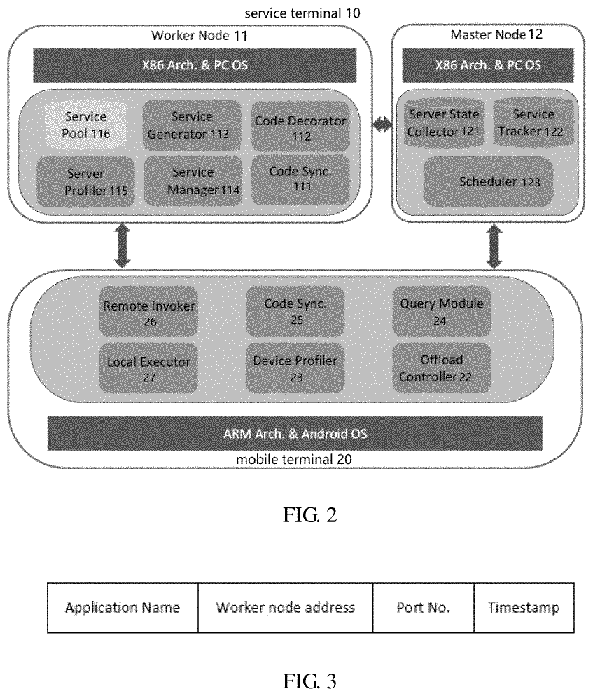

The LCCS framework architecture proposed herein includes three major parts: the smart phone client, the master node to schedule offloading tasks and a set of worker nodes to maintain different services, which is illustrated in FIG. 2. That is, FIG. 2 is a schematic diagram showing framework architecture of the LCCS.

The smart phone client is based on the ARM CPU architecture and the Android operating system. As shown in FIG. 2, a mobile terminal 20 (such as a smart phone) of this architecture has six parts that support offloading compute-intensive tasks, which may be an offload controller 22, a device profiler 23, a query unit 24, a code sync unit 25 and a remote invoker 26. The six parts may be implemented by software or hardware, which are not limited hereto.

The offload controller 22 is the unit to determine whether the code of compute-intensive tasks should be offloaded based on device information collected by the device profiler 23, e.g. code scale and network environment. Besides, the device profiler 23 also monitors the execution and generates history records both in remote mode and local mode to help the offload controller 22 make decisions. The query unit 24 is the unit to query whether the cloud service terminal 10 has already contained the corresponding calculating service, which is critical to the efficiency of offloading. The code sync unit 25 is the unit to synchronize the code of compute-intensive task to the worker node 11. In another embodiment, the mobile terminal 20 further includes a local executor 27, the local executor 27 ensures the integrity of the application functionality won't be affected by the poor network or other reasons, and the remote invoker 26 is the unit to access the calculating service and obtain the results.

The master node 12 may be based on the x86 CPU architecture and personal computer operating systems, including Linux and Windows. The duty of the master node 12 is to handle offloading requests from mobile terminals 20 and schedule new services.

The master node 12 may include a service state collector 121, a service tracker 122 and a scheduler 123. The server state collector 121 collects states from the worker nodes 11, while the service tracker 122 tracks different services statuses distributed on different worker nodes 11. The scheduler 123 uses the information from the service tracker 122 to check whether the corresponding calculating service 11b exists and uses the information from the server state collector 121 to determine which worker node 11 is going to generate and maintain a new service.

The worker nodes 11 may also be based on the x86 CPU architecture and personal computer operating system, but they may have different duty against the master node 12. There may be five major units in a worker node 11, which may be a code sync unit 111, a code decorator 112, a service generator 113, a service manager 114 and a service profiler 115.

The code sync unit 111 receives the code transmitted from the smart phone and stores the code to the specific place. The code decorator 112 decorates the raw code using the tool code which is deployed previously and makes the decorated code able to be compiled. The Service Generator 113 is the unit to generate corresponding service through a series of compilation and running actions.

The service manager 114 is used to manage the lifecycle of each service 11b. The server profiler 115 collects its own statuses and sends the information to the master node 12, including CPU utilization rate, memory occupancy status, I/O occupancy status and occupied port number. A service pool 116 is to describe the set that contains different kinds of services which have their own lifecycles.

Compared with the prior art, the disclosure has the following advantages:

1) The Loose Coupling Client and Server framework (LCCS) system is not only able to reduce the power consumption and enhance the performance of mobile terminals, but also reduce the burden of application development.

2) The LCCS system has a loose bond between applications and cloud servers with the heterogeneous underlying architecture, which makes cloud providers be able to provide generic but self-customized cloud offloading services for different applications.

3) In The LCCS system and the method for executing computation offloading, the lifecycle mechanism is proposed for offloading services on cloud servers to further reduce the time and energy consumption of service deployment for the same application on different mobile terminals.

Second Embodiment of LCCS Implementation

In an embodiment of the present application, there is provided with a method for performing computing offloading. As the LCCS system in the first embodiment includes two major parts: the mobile terminal 20 and the service terminal 10. Herein after, the operations of the mobile terminal 20 and the service terminal 10 are illustrated hereinbelow respectively.

In an embodiment, the mobile terminal 20 may firstly have a communication with the service terminal 10.

After the offload controller 22 determines to offload, the query unit 24 on the mobile terminal 20 establishes a TCP connection with the master node 12 and access a webservice interface provided by the master node 12 based on HTTP, which is also the pattern for code synchronization. The remote invocation is also based on TCP, but in some embodiments, it doesn't utilize HTTP.

In an embodiment, the mobile terminal 20 may secondly perform a code synchronizing.

The LCCS has the most fine-grained offloading, which is method level offloading, which means it can achieve maximum offloading efficiency because developers can use least code to construct the compute-intensive task. Code synchronizing is the first step of computation offloading after the Offload Controller 22 makes the determination to offload. Its primary function is to offload the code of compute-intensive task from Android smart phones to the service terminal 10.

In an embodiment, when applying in Android based terminals, there are several rules for code synchronizing that need to be followed by Android developers:

1) The code that need to be offloaded should not have any functions related to smart phone hardware, such as G-sensor and GPS-sensor.

2) The Android applications need to provide their package names and application names according to the unified naming rules, so that different services can be managed by the cloud server in a convenient and unified way.

3) The methods that need to be offloaded should be declared in an interface named OffloadService.

4) Developers need to package the methods and their context methods into a class named OffloadServiceImpl, which implements the interface OffloadService.

5) These methods that need to be offloaded can only be declared as public member methods rather than the class methods.

In LCCS, the Offload Controller 22 offers developers great flexibility to determine the time for code synchronization, which brings great flexibility and convenience to design and develop Android applications. Code synchronization can be carried out immediately after the applications are initiated, which could eliminate the time to wait for the deployment. It is also available to set the time for code synchronization to be the time just before remote invocation begins, or any time between these two points.

In an embodiment, the mobile terminal 20 may thirdly perform a remote invocation.

After the corresponding service is deployed, the application is able to initiate the remote invoker 26 to invoke the remote service. However, as described above, the mobile terminal 20 such as the Android smart phone and personal computer have different execution environments from CPU structure, virtual machine to the executable file format. So, it is impossible for a smart phone to directly invoke the remote service on a personal computer, and that is the reason why many offloading systems choose the Android x86 platform to be the server OS. But LCCS provides an SDK tool for Android application developers to realize remote invocation between the smart phone and the server with heterogeneous structures.

To solve the problem of incompatibility between the mobile terminal 20 (such as the smart phone) and the service terminal (such as a cloud server) 10, the LCCS according to an embodiment of the present invention establishes elementary units for unified remote invocation: an interface named RemoteMessage and a class named RemoteInstance. Both implement the interface Serializable to achieve serial transmission through TCP. Besides, LCCS uses the class RemoteCall and the class RemoteReturn as the elementary unit for method invocation and returning respectively, and both implement the interface RemoteMessage. In addition, the SDK tool package contains the class Client for mobile terminal 20 and the class Server for cloud server 10. Both the instance of Client and the instance of Server contain the Map data structure to save the object instance of RemoteCall and its proxy object instance respectively. It is capable to use TCP to realize a reliable connection between the class Client and the class Server. Finally, the remote invocation utilizes the Java reflection mechanism to ensure the consistency between the client 20 and the server 10.

To the implementation in service terminal 10, the service is the replica of the corresponding compute-intensive task which is generated and located on worker node and it provides offloading service for the specific application. A service maintained by a worker node 11 has a specific address which includes a worker node address and a specific port number. Besides, a service will survive for a period depending on the request frequency of the application. As discussed above, the existence of the service is critical to the efficiency of offloading because it can save a lot of power consumption and time for code synchronization and service deployment by providing a direct remote invocation offloading mode.

In an embodiment, the service terminal 10 may firstly perform a query logic.

The first step of an internal offloading process starts with the query. To avoid the service delay brought by duplicate compilation and execution on same code, the application needs to confirm the existence of the available service instead. The master node 12 provides a webservice interface for mobile terminal 20 such as the Android smart phones to check whether the corresponding service exists. When an application requests for the offloading service, the Scheduler 123 will find the appropriate worker node 11 based on the information collected by Service Tracker 122 and Server State Collector 121. Once receives the request, the Scheduler 123 inquires the Service Tracker 122 to determine the existence of the available service which refers to the latest version and time expiration of the service. If the service is the latest version and has not been terminated by the Service Manager 114, then the query unit 24 will get the response containing address and port of the worker node 11 where the corresponding service exists.

Otherwise, the Scheduler 123 will inquire the Server Status Collector 121 to search for the idlest worker node 11 to deploy the new service.

In an embodiment, the service terminal 10 may secondly perform a service deployment.

There are three steps to complete service deployment at the worker node 11: code synchronization, code decoration and service generation. Code synchronization is executed on Code sync unit 111 which provides an interface for applications to upload the original code. After receiving the code completely, the Code sync unit 111 puts the code into an interface file and implementation file at the specific position respectively for next step: code decoration.

The Code Decorator 112 is driven by the Code sync unit 25 after finishing code synchronization. To make different kinds of original codes become sustainable services and reduce the coupling degree, it may need to modify these original codes in a generic and dynamic way no matter how contents are different in these codes. At the code decoration phase, it is needed, firstly, to get the interface file content, append it behind the package name and put it back. Second, it is capable to get the tool code and the original code from the tool code file and implementation file respectively. After that, it is capable to extract the proper code from the tool code and the original code using regular-expression related function, concatenate them together and substitute the interface name to make the new-generated code be able to be compiled. As a matter of fact, the original code does not generally contain any code related to service generation. Therefore, it is capable to utilize two classes “Socket” and “ServerSocket” in package “Java.net” to generate a service and put it into the tool code file.

Service generation, the service deployment consists of code compilation phase and code start-up phase, which needs to be asynchronously invoked by the previous step to response to the application in time. In service deployment step, it is capable to utilize the program execution functions to execute code compilation and start-up dynamically just like executing the corresponding “javac” and “java” commands from the command line in operating system.

A Service Pool 116 is the collection of all active services in one worker node 11, while each service is the replica of compute-intensive tasks corresponding to one kind of application. Each service contains one or several callable methods depending on developer's decision. During service providing, there must be the case that different smart phones with the same application request for same computation offloading service aiming at the same computing component. As mentioned previously, it is necessary to improve the quality of service and shorten the offloading service cycle through cutting down the service deployment time and offering the existing service to smart phones for direct invocation. Therefore, cloud service provider needs to establish a uniform identity or naming rule for all services to achieve unified application scheduling and to find the corresponding service for an application quickly and accurately.

In offloading service providing, the uniform identity rule is primarily executed by the master node 12. A complete service identity hold by Service Tracker 122 at least contains four parts as shown in FIG. 3.

Full application name including package name, worker node address, service port number and a timestamp for lifecycle limitation. FIG. 3 is a block chart showing the structure of a service identity. In fact, a worker node 11 needs to hold the identity information of all local services to manage them and send the information to master node 12 timely. In contrast, the master node 12 holds the identity information of all available services distributed on all worker nodes 11 to schedule offloading tasks and to response to offloading requests.

In an embodiment, the service terminal 10 may thirdly perform a service management.

Service management mainly refers to service lifecycle management which is executed by the Service Manager 114. It is true that keeping a service with a quite long life is beneficial to the efficiency and energy saving for multiple offloading requests of the same application from different mobile terminals 20. But the waste of resource on memory, CPU, and port number at worker node 11 caused by a long period of no request status is also a non-negligible fact. It is beneficial for worker node 11 to kill these idle processes, but killing a service prematurely will, on the contrary, increase the unnecessary waiting time of service redeployment. In addition, when the computing module in the application is updated, how to ensure that the service can be updated in time is also an important measurement indicator to the quality of service. Essentially, the issue of service updating has no difference from the lifecycle problem. Therefore, how to determine the service lifecycle properly is quite an important issue.

A server profiler 115 is the unit to collect resource usage statuses. After getting the information, server profiler 115 sends the information to the master node 12 to help the master node 12 select appropriate worker node 11 to response to the new offloading request. However, the information update frequency occupies a certain amount of network resources which will affect the performance of request handling. Therefore, the worker nodes 11 use the mean value in a period of time to stand for the average level of each kind of resource, which, in other words, reduces the frequency of information transmission and alleviates the burden of the master node 12.

As stated above, the concept of LCCS is to establish a cloud computation offloading service provider which can provide generic offloading service for different kinds of applications. In fact, if establishing a generic offloading cloud service for third-party developers, the server needs to endure many offloading requests from different applications. So, it is necessary to establish a distributed server and adopt appropriate load balancing mechanism. Herein, two distributed servers and the corresponding load balancing mechanism are proposed, which a star topology distributed server and a Peer-to-Peer Distributed Server.

Introduction of Star Topology Distributed Server.

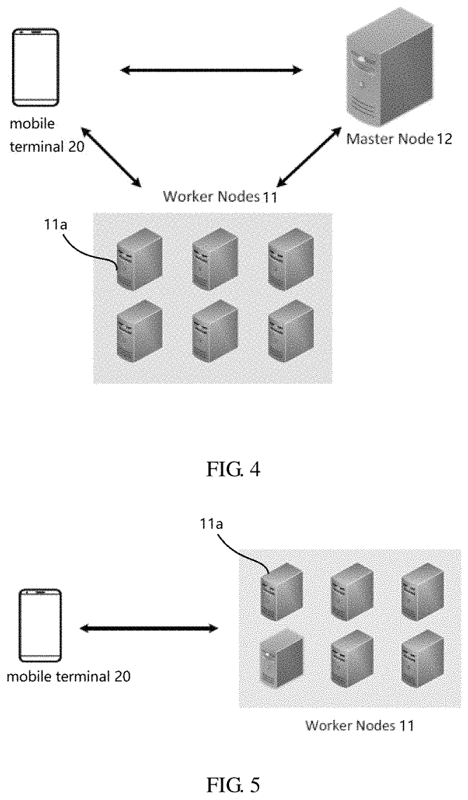

Star topology is one of the most prevailing computer network topology and there are many distributed frameworks using star topology, such as Hadoop, Mesos and so on. The star topology distributed server includes many worker nodes and a fixed master node as the center of topology. FIG. 4 shows the overall architecture of the server based on star topology. In LCCS of the embodiment, a complete offloading request includes two phases: a query phase and an offloading phase. In the first phase, the application that intends to offload its compute-intensive task needs to send the request to query the worker node address for available service or new service deployment. In offloading phase, the application needs to deploy the code of its compute intensive task to the corresponding worker node or directly invoke the remote service, which depends on the response result of query phase. In star topology, the master node is responsible for handling the query requests from different applications and sending the worker node address back based on the information of worker nodes statuses and available services. It is capable to use load information to denote both server status and available services. Before that, the master node needs to communicate with all worker nodes to obtain the resource usage statuses of worker nodes and update its Service Tracker. Worker nodes 11 are responsible for handling offloading requests, including service deployment, service maintaining and task execution.

Introduction of Peer-to-Peer Distributed Server

The peer-to-peer topology is also one of the most common computer network topologies and there are many distributed frameworks using peer-to-peer topology, such as torrent file sharing system. Unlike most peer-to-peer system, the server 10 based on peer-to-peer doesn't have complicated routing and resource discovery process. Compared with the server based on star topology, peer-to-peer server 10 has no fixed center node, which means computers in server end are all worker node and these nodes are equivalent. FIG. 5 gives the server architecture based on peer-to-peer topology. There is only one kind of nodes in the server 10 based on peer-to-peer topology and all these nodes are connected to each other through Ethernet. When receiving an offloading request from an application, the server 10 will utilize the load balancing mechanism to find for the appropriate node 11 to handling the request. Due to the lack of center node in peer-to-peer topology, there is no unified scheduling strategy in the peer-to-peer server 10. Therefore, each node 11 needs to communicate with other nodes to realize the information sharing, which means the worker node is both the request distributor and task executor.

Comparison Between Two Topologies Because of the topology structure, the functions of master node 12 and worker node 11 are completely independent. The master node 12 is only responsible for task scheduling and load information maintaining, while other worker nodes 11 are only responsible for service maintaining and task execution. Each offloading request from applications affects only master nodes 12 and one of the worker nodes 11. The server 10 based on star topology has the advantages of simple configuration, easy management and low cost for maintaining the load information. Nevertheless, the disadvantage is that the sever 10 is not robust enough because the server 10 relies too much on the scheduling of the master node 12. The breakdown of a single worker node 11 may not have much influence, but if the breakdown happens to the master node 12, then it will have a devastating impact on the server 10, which means the entire system will become paralyzed. Besides, a single master node 12 has limited ability. If the load of master node 12 is increasing along with the growing number of offloading requests, the performance of the center node will become the bottleneck of entire system finally.

For the server based on peer-to-peer topology, worker nodes are both request distributor and task executor, so all the worker nodes need to communicate with each other for sharing load information and every node need to maintain the information. Each offloading request for new service deployment will affect the whole system. This kind of server has the advantage of high reliability and robust. The breakdown of few nodes won't affect scheduling and service query because load information is distributed on different worker nodes and each node is able to realize task scheduling. However, because of the lack of center node to manage the information, the consistency of load information will become more complicated.

There is further provided Load Balancing Mechanism for the servers.

Load balancing can be implemented in a variety of ways, including hardware level and software level. The load balancing mechanism proposed herein is a dynamic software level strategy which is depicted corresponding to two different distributed servers respectively. The load balancing mechanism is mainly focus on task scheduling, which can be divided into two major parts: load information updating and node selection. Due to the topology characteristics, the fixed master node in star topology ensures the consistency of load information. However, peer-to-peer server doesn't have fixed master node to scheduling and there are multiple backups of load information, which will absolutely lead to the duplicate services and inconsistency of information. In order to avoid the ambiguity and resource waste brought by the problem, a temporary master node in peer-to-peer server is proposed. The temporary master node is the node which holds the same function just like the fixed master node in star topology, but itself also maintains partial offloading services. Unlike the fixed master node, the worker node as the temporary master node changes over time. Obviously, the scheduling performance of temporary master node is not good as the fixed master node, but it is also a compromise to improve the robustness of the server.

According to an embodiment of the present invention, in the first step, there is provided load information updating mechanism.

The load information can be divided into server status information and available services information.

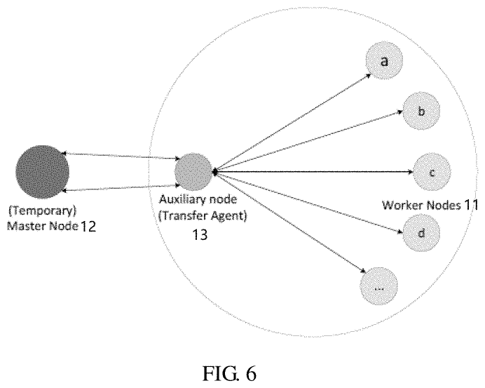

In the star topology server, as the master node 12 is the scheduler of tasks, service information can only be generated by itself. On the other hand, server status information is generated by worker nodes 11, which changes with time constantly. Excessively updating server status information can affect the performance of receiving and scheduling offloading requests. As a result, in the star topology server, an auxiliary node 13 is introduced to help the master node 12 update the server status information, which is illustrated in FIG. 6. It is capable to transfer the frequent connects from master node 12 to auxiliary nodes 13 to reduce the IO costs on the master node 12, which makes the master node 12 concentrate on handling offloading requests. The master node 12 no longer needs to acquire real time server status information but to get the information from the auxiliary node 13 regularly, while the auxiliary node 13 updates the information from worker nodes 11 frequently to get the average level of server status.

Load information updating in peer-to-peer server is quite different because load information exists in all worker nodes 11 and master node 12 is temporary. It is very common to generate inconsistent information in peer-to-peer server. There are two ways for temporary master node 12 to update load information. The first way is to use broadcast to update the load information to other worker nodes 11, which may lead to broadcast storm. Another way is to update the information point-to-point but it will cause a great diminish on the performance of temporary master node 12.

Considering the two methods above, a fixed worker node 11 is chosen as the transfer agent node 13 between temporary master node 12 and other worker nodes 11 which is also shown in FIG. 6. The transfer agent node 13 is kind like the assistant node in star topology but itself also maintains partial services.

As for the service information updating, when a new service is generated by temporary master node 12, this record will be sent to the transfer agent node 13 immediately. And after that, the transfer agent node 13, as the new initiator of the information update, asynchronously sends this record to all other worker nodes 11. In contrast, the information of server status coming from the worker nodes 11 will be sent to the transfer agent node 13 firstly and after that, the transfer agent sends the average value about server status in a period to the temporary master node 12.

Herein, the reason why the update is initiated by master node 12 is to avoid the problem caused by updating delay in another updating mode dominated by worker node.

Suppose To represents the time when the application starts an offloading request and Tu is the time when the corresponding information is completely updated in temporary master node. If To<Tu, then the temporary master node will regenerate a new service because no related record is found. It may lead to the situation that two different worker nodes maintain the same service, which means information ambiguity may exist in temporary master node.

According to an embodiment of the present invention, in the second step, there is provided Node Selection mechanism.

Unlike some cloud services, computation offloading is a time sensitive cloud service for most mobile applications. After receiving an offloading request, cloud service providers should handle this request as soon as possible to reduce the time delay. Node selection, as the indispensable phase of computation offloading, consists of worker node selection and temporary master node shift.

Compared with the prior art, the disclosure has the following advantages:

1) LCCS system is not only able to reduce the power consumption and enhance the performance of mobile terminals, but also reduce the burden of application development.

2) LCCS system has a loose bond between applications and cloud servers with the heterogeneous underlying architecture, which makes cloud providers be able to provide generic but self-customized cloud offloading services for different applications.

3) In LCCS system and the method for executing computation offloading, the lifecycle mechanism is proposed for offloading services on cloud servers to further reduce the time and energy consumption of service deployment for the same application on different mobile terminals.

It should be noted that, the embodiment of the disclosure further discloses computer program, comprising computer readable codes, wherein when the computer readable codes are carried out on a server, the server executes the method for performing peak clipping to multiple carrier waves according to any one the embodiments above.

In addition, the embodiment of the disclosure further disclose a medium which stores the computer program. The medium includes but not limited as mechanisms such as computer readable storage or information transmission ways. For example, the medium includes read only memory (ROM), random access memory (RAM), Disk storage medium, optical storage medium, flash storage medium, transmission signals with the form of electric, light, sound and other forms (such as carrier wave, infrared signal, digital signal).

The embodiments in the disclosure is described step by step, the important part of each embodiment mainly lies in the difference between other embodiments, the same or similar part between each embodiments may be referred to each other. The device embodiments are similar to the method embodiments, thusly the description is relatively simple, the related part may be referred to the parts of the method embodiments.

The LCCS system and the method for executing computation offloading are illustrated in the above, the examples in the disclosure are used to illustrate the disclosure, the embodiments above are only made for help understanding the method and the core concept of the disclosure. It is obvious for an ordinary skilled person in the art that modifications and variations could be made without departing from the scope and spirit of the claims as appended. For the scope of the disclosure, the inventive disclosure is illustrative rather than restrictive, and the scope of the disclosure is defined by the appended claims.

What is claimed is:

1. A LCCS system comprising a server terminal (10) and a plurality of mobile terminals (20):
wherein the service terminal (10) comprises a plurality of worker nodes (11) and a master mode (12), the worker nodes (11) comprises a plurality of servers (11a), each server (11a) is configured to provide at least one type of calculating service (11b) corresponding to one type of application (211) installed in mobile terminals (20); and
each mobile terminal (20) is installed with at least one application (211), the applications (211) correspond to the calculating services (111) provided by the servers (11a).

2. The LCCS system according to claim 1, wherein each of the mobile terminal (20) comprises an offload controller (22), a device profiler (23), a query unit (24), a first code sync unit (25) and a remote invoker (26);
the offload controller (22) is configured to determine whether code of a compute-intensive task should be offloaded based on device information of the mobile terminal (20) collected by the device profiler (23);
the device profiler (23) is configured to monitor execution and generate history records both in a remote mode and a local mode of the mobile terminal (20) to help the offload controller (22) and send profiling information to the offload controller (22);
the query unit (24) is configured to query whether the service terminal (10) includes calculating service (11a) corresponding to the compute-intensive task;
the first code sync unit (25) is configured to synchronize the code of compute-intensive task to the worker nodes (11); and
the remote invoker (26) is configured to access the service terminal (10) and obtain a calculating result of the compute-intensive task.

3. The LCCS system according to claim 2, wherein the mobile terminal (20) further comprises a local executor (27), and the local executor (27) is configured to ensure the integrity of the application functionality.

4. The LCCS system according to claim 1, wherein the master node (12) of the service terminal (10) is configured to an offloading request from the mobile terminal (20) and schedule a calculating service;
the master node (12) comprises a server state collector (121), a service tracker (122) and a scheduler (123);
the server state collector (121) is configured to collect states from worker nodes (11);
the service tracker (122) is configured to track different service statuses distributed on different worker nodes (11);
the scheduler (123) is configured to use the information from the service tracker (122) to check whether the calculating service exists and use the information from the server state collector (121) to determine the worker node (11) which generates and maintains the calculating service.

5. The LCCS system according to claim 1, wherein the worker node (11) comprises a second code sync unit (111), a code decorator (112), a service generator (113), a service manager (114) and a server profiler (115);
the second code sync unit (111) is configured to receive the code transmitted from the mobile terminal (20) and stores the code;
the code decorator (112) is configured to decorate the code using a tool code and make the decorated code compliable;
the service generator (113) is configured to generate calculating service corresponding to the compute-intensive task;
the service manager (114) is configured to manage the lifecycle of each calculating service (11b);
the server profiler (115) is configured to collects status of the server and send information to the master node (12), wherein the statues comprises CPU utilization rate, memory occupancy status, I/O occupancy status and occupied port number.

6. The LCCS system according to claim 5, wherein the worker node (11) further comprises a service pool (116), the service pool (116) is the set that includes a plurality of calculating services each of which has a lifecycle.

7. The LCCS system according to claim 1, wherein the service terminal (10) comprises star topology distributed servers or peer-to-peer distributed servers.

8. The LCCS system according to claim 1, wherein the service terminal (10) comprises peer-to-peer distributed servers, the peer-to-peer distributed servers comprise a temporary master node to ensure the consistency of load information.

9. The LCCS system according to claim 1, wherein the service terminal (10) comprises star topology distributed servers, the service terminal (10) include an auxiliary node to help the master node update server status information.

10. The LCCS system according to claim 1, wherein the service terminal (10) is further configured to perform node selection, comprising:
updating server status;
selecting worker node; and
updating available service information.

11. The LCCS system according to claim 10, wherein the service terminal (10) comprises peer-to-peer distributed servers, the peer-to-peer distributed servers comprise a temporary master node to ensure the consistency of load information, the service terminal (10) is further configured to perform:
selecting node according to updated load information.

12. A method for executing computation offloading from a mobile terminal (20) to a server terminal (10), the method comprising:
establishing connection with a master node of the server terminal (10) and accessing a webservice interface provided by the master node;
establishing an elementary unit for unified remote invocation;
determining whether a calculating service corresponding to a compute-intensive task exists;
performing a service deployment.

13. The method according to claim 12, wherein the step of performing the service deployment comprises:
providing an interface for applications to upload code of the compute-intensive task;
after receiving the code, disposing the code into an interface file and an implementation file, respectively;
obtaining the interface file, and appending behind the package name and putting the interface file back;
obtaining tool code from a tool code file, and obtaining the disposed code from the implementation file, respectively;
extracting code from the tool code and the disposed code using regular-expression related function;
concatenating and substituting the interface name to make the new-generated code be able to be compiled;
complying the code and start-up the calculating service.

14. The method according to claim 12, wherein in step of establishing an elementary unit for unified remote invocation, an SDK tool is provided to realize remote invocation between the mobile terminal (20) and the service terminal (10) with heterogeneous structures, wherein the elementary unit has an interface named RemoteMessage and a class named RemoteInstance, both the RemoteMessage and the RemoteInstance implement the interface serializable to achieve serial transmission through TCP, a class RemoteCall and a class RemoteReturn are used as the elementary unit for method invocation and returning respectively, and both of the class RemoteCall and the RemoteReturn implement the interface RemoteMessage.

15. The method according to claim 12, wherein step of determining whether the calculating service corresponding to a compute-intensive task exists comprises:
determining the appropriate worker node (11);
once receives a request of the compute-intensive task, inquiring a service tracker to determine the existence of the available calculating service;
if the calculating service exist, obtaining a response containing address and port of the worker node (11) where the corresponding service exists.
if the calculating service does not exist, searching for an idle worker node (11) to deploy the calculating service.

16. The method according to claim 12, wherein the method further comprises:
managing service lifecycle of the service.

17. The method according to claim 13, wherein the step of performing the service deployment further comprises:
updating load information of the working nodes; and
selecting available node from the working nodes according to the load information.

18. The method according to claim 17, wherein the load information comprises:
server status information, and, available services information.
